(19) United States
(12) Patent Application Publication
(10) Pub. No.: US 2014/0115319 A1
(43) Pub. Date: Apr. 24, 2014

(54) APPLICATION LAYER ENCRYPTED PACKET ROUTING

(71) Applicant: Lockheed Martin Corporation, Bethesda, MD (US)

(72) Inventor: David May, The Villages, FL (US)

(73) Assignee: Lockheed Martin Corporation, Bethesda, MD (US)

(21) Appl. No.: 14/059,863

(22) Filed: Oct. 22, 2013

Related U.S. Application Data
(60) Provisional application No. 61/717,255, filed on Oct. 23, 2012.

(51) Int. Cl. H04L 29/06

(52) U.S. Cl. CPC H04L 63/0428
USPC 713/150

(57) ABSTRACT

Mechanisms for cloaking, or otherwise masking, information in packets communicated between nodes. A source node generates a packet comprising communication layer data and encrypted application layer data. The encrypted application layer data includes a payload and waypoint data. The waypoint data includes a waypoint list that identifies one or more nodes of a path of nodes that the packet is to transit from the source node to the destination node. The source node addresses the packet to an intermediate node on the path, and sends the packet toward the intermediate node.

### RELATED APPLICATIONS

This application claims the benefit of provisional patent application Ser. No. 61/717,255, filed Oct. 23, 2012, entitled ENCRYPTED MESSAGE ROUTING, the disclosure of which is hereby incorporated herein by reference in its entirety.

### TECHNICAL FIELD

The embodiments relate generally to communicating packets over a network, and in particular to mechanisms for cloaking information that may otherwise be gleaned by an interceptor of messages, such as the identity of true source and destination nodes on the network.

### BACKGROUND

Wireless communications are often not only more convenient than wired communications, but are sometimes necessary, such as communications between an airborne device and another device.

One downside to wireless communications is that wireless signals are generally broadcast in a manner that devices other than the intended destination device may be able to receive the wireless signals. This attribute of wireless communications allows an interloper to receive such communications, and glean information from the communications that may be used to someone's detriment.

Certain communication protocols have become omnipresent and are widely used for communicating data from a source node to a destination node. TCP/IP is one such communication protocol. Packets communicated via TCP/IP have a communication layer utilized by routing devices, such as routers, bridges and switches, for communicating a packet from a source node to a destination node. Such packets also have an application layer that includes the payload, i.e., the data that is being communicated from the source node to the destination node. The application layer of the packets is sometimes encrypted to foil an interloper, but a communication layer of the packets must often remain unencrypted to allow for the packets to be routed from a source node to a destination node through one or more switching devices.

Unfortunately, the interloper can ascertain a substantial amount of information about a network from the information contained in the communication layer of the packets, such as the IP addresses of source and destination nodes on a network, which nodes communicate most with other nodes, the likely type of traffic contained in such packets, and the like. This information can be used by the interloper to disrupt the network, and/or to gather intelligence about the network infrastructure.

### SUMMARY

The present embodiments relate to cloaking, or otherwise masking, routing information in packets communicated between nodes on a network that may otherwise be utilized by interlopers, such as hackers and the like, to acquire knowledge about the network.

In one embodiment, a method for communicating data from a source node to a destination node is provided. The source node generates a first packet that includes first communication layer data and first encrypted application layer data. The first encrypted application layer data includes a first payload, and first waypoint data that includes a first waypoint list that identifies one or more nodes of a first path of nodes that the first packet is to transit from the source node to the destination node. The source node addresses the first packet to an intermediate node on the first path, and sends the first packet toward the intermediate node.

In another embodiment, a method for receiving a packet by an intermediate node is provided. The intermediate node receives, from an upstream node, a packet comprising communication layer data and encrypted application layer data. The encrypted application layer data includes a payload and waypoint data that includes a waypoint list that identifies one or more nodes of a path of nodes that the packet is to transit from the source node to the destination node. The intermediate node decrypts at least the waypoint data, and determines a next node on the path based on the waypoint data. The intermediate node addresses the packet to the next node on the path, and sends the packet toward the next node.

In yet another embodiment, a method for receiving a packet by a destination node is provided. The destination node receives a packet from an upstream node that includes communication layer data and encrypted application layer data. The encrypted application layer data includes a payload and waypoint data that includes a waypoint list that identifies one or more nodes of a path of nodes that the packet is to transit from a source node to the destination node. The destination node decrypts at least the first waypoint data, and based on the waypoint data, the destination node determines that the node is the destination node, and consumes the first payload.

In one embodiment, the source node generates a plurality of video packets for communication to a destination node. For at least some of the video packets, the source node generates different waypoint lists that identify different paths of nodes from the source node to the destination node, such that at least some of the video packets take different paths through intermediate nodes from the source node to the destination node.

In one embodiment, the source node determines a random plurality of intermediate nodes of a group of nodes, and a random sequence of the plurality of intermediate nodes to form a path of nodes over which a packet will traverse from the source node to the destination node.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a block diagram of a system in which embodiments may be practiced;

FIG. 2 is a flowchart of a method for communicating a packet from a source node to a destination node according to one embodiment;

FIG. 3 is a flowchart of a method for relaying a packet received from an upstream node toward a downstream node by an intermediate node according to one embodiment;

FIG. 4 is a flowchart of a method for receiving a packet by a destination node according to one embodiment;

FIG. 5 is a flowchart of a method for determining a waypoint list according to one embodiment;

FIG. 6 is a block diagram of a format for an example packet according to one embodiment;

FIG. 7 is a block diagram illustrating consecutive packets being sent by a source node to a destination node using different waypoint lists, according to one embodiment;

FIG. 8 is a block diagram of a system in which additional embodiments may be practiced;

FIG. 9 is a block diagram of a system in which additional embodiments may be practiced; and

FIG. 10 is a block diagram of an example node according to one embodiment.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The present embodiments relate to cloaking, or otherwise masking, information in packets communicated between nodes on a network that may otherwise be utilized by interlopers, such as hackers and the like, to acquire knowledge about the network.

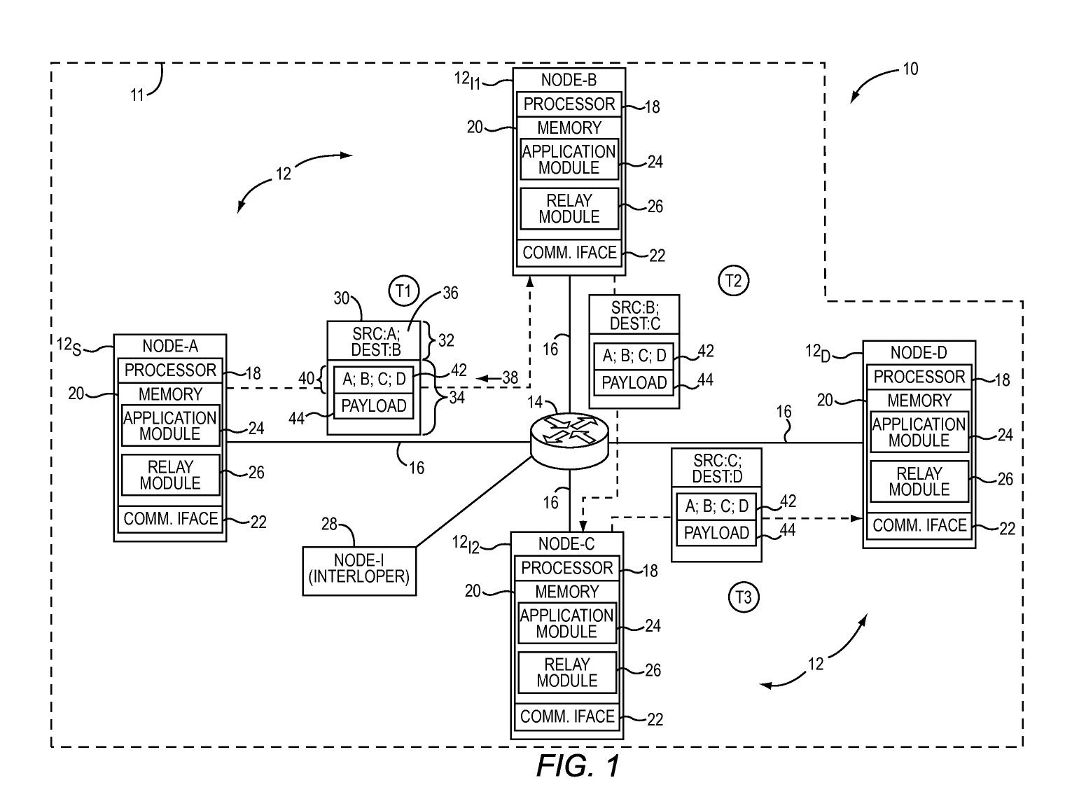

FIG. 1 is a block diagram of a system 10 in which embodiments may be practiced. The system 10 includes a network 11 that is made up of a plurality of nodes 12 and one or more switches 14. The nodes 12 may, for any particular packet, be a source node 12_{S} if such node 12 is originating the particular packet, an intermediate node 12_{I} if such node 12 is neither the originating node 12 nor a destination node 12 of the particular packet, or a destination node 12_{D} if such node 12 is the intended recipient of the particular packet for consumption (i.e., use) of the contents of the packet. Thus, an intermediate node 12_{I} for one packet may be a source node 12_{S} for another packet originated by such node 12, and a destination node 12_{D} for yet another packet. A node 12 may comprise any computing device capable of communicating with other computing devices via a wired or wireless connection, including, for example, a desktop or laptop computer, a smart phone, a computing tablet, a camera, a video camera, a missile, an aircraft such as an airplane or a helicopter, a ground vehicle, a satellite, and the like. While for purposes of illustration only four nodes 12 are illustrated, the system 10 may include hundreds or thousands of nodes 12.

The system 10 may also include one or more switches 14 that are coupled to the nodes 12, or to other switches 14, via communication links 16. The switch 14 receives packets from one node 12, or switch 14, and routes, or otherwise switches, the received packets to another node 12, or switch 14, based on information in a communication layer of the received packets. In terms of the Open Systems Interconnection (OSI) model (ISO/IEC 7498-1), the switch 14 operates by processing data contained in layers 1-3 of the packets to determine where the received packets should be switched. Such information may comprise, for example an Internet Protocol (IP) address of a node 12 to which the packet is being sent. The communication links 16 may comprise wired communication links, wireless communication links, or a combination thereof.

Each node 12 may include a processor 18, a memory 20, and a communication interface 22 that is configured to communicate via a respective communication link 16. The memory 20 may include an application module 24 that provides a desired functionality for the respective node 12. By way of non-limiting example, the application module 24 may comprise a module that receives video packets and displays the contents on a display, or a module that receives audio packets and plays the contents via an audio system, or may comprise a module that processes data in packets and outputs certain material based on such data. Generally, the application module 24 “consumes,” i.e., uses, data contained in an application layer of the packet if the node 12 is a destination node 12_{D}, or originates data contained in the application layer if the node 12 is a source node 12_{S}.

As another example, the source node 12_{S} may comprise an airborne drone that generates images and communicates the images to the destination node 12_{D}. In this example the application module 24 in the source node 12_{S} may continually, over a period of time, generate frames of images, put consecutive frames of images into the application layer of a plurality of consecutive packets, and communicate the packets to the destination node 12_{D}. The application module 24 in the destination node 12_{D} may receive the packets, extract the images from the packets, ensure images are received in a proper order via a sequence number contained in the packets, and display the images on a display (not illustrated). Note that each such packet may be switched by the switch 14, but the switch 14 need not access the application layer data, which includes in this example, the images, in order to switch the packet properly, because each such packet also includes a communication layer that identifies a node 12 to which the packet is addressed.

The memory 20 may also include a relay module 26. While for purposes of illustration the relay module 26 is shown as being separate from the application module 24, the embodiments are not limited to any particular division of functionality among components of the node 12, and the relay module 26 may be integrated with the application module 24 in some embodiments. The relay module 26, among other features as discussed in greater detail herein, receives a packet addressed to the node 12 with which the relay module 26 is associated, determines whether the packet is ultimately destined for another node 12, and if so, alters the destination address of the packet, and sends the packet toward the another node 12. The phrase “sends toward” as used herein means that a sending node 12 addresses a packet to a particular recipient node 12, and communicates the packet onto a communication link 16, but on its way to the recipient node 12, the packet may be routed or switched by any number of switches 14. While for purposes of illustration functionality may be attributed to a particular component of the node 12, such as the application module 24, relay module 26 or communication interface 22, generally, functionality performed by any component of the node 12 may be attributed to the node 12 without identifying the particular component that implements the functionality, since the embodiments are not limited to any particular implementation of the node 12.

In this example, an interloper 28 is also communicatively coupled to the network 11, and may be able to receive packets communicated over a communication link 16. The interloper 28 may have gained physical access to the switch 14, or a communication link 16, or one or more of the communication links 16 may comprise wireless communication links, and the interloper 28 may be capable of receiving packets wirelessly communicated from any of the nodes 12. From the perspective of the operator of the system 10, the interloper 28 is an undesirable receiver of information communicated in the system 10, and the interloper 28 may use information gleaned from received packets in a manner that is detrimental to the operator of the system 10, or others.

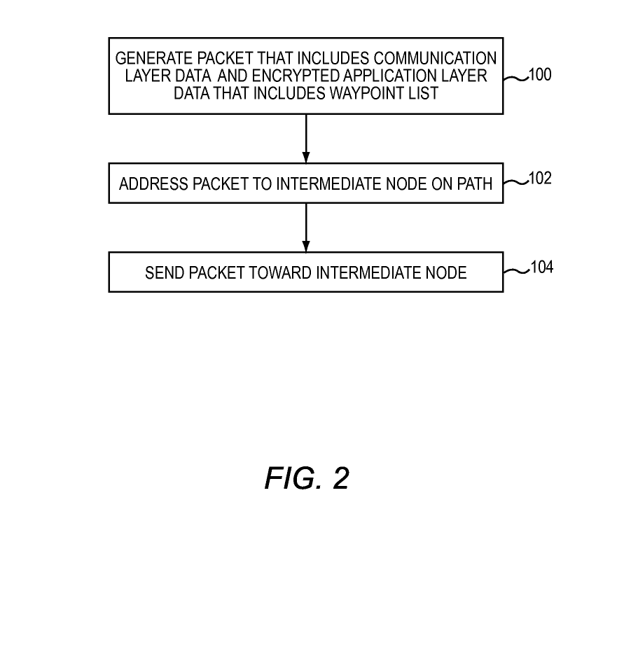

FIG. 2 is a flowchart of a method for communicating a packet from the source node 12_{S} to the destination node 12_{D} according to one embodiment. FIG. 2 will be discussed in conjunction with FIG. 1. For purposes of illustration, assume that at a time T1, the source node 12_{S} generates a packet 30 for communication to the destination node 12_{D} (FIG. 2, block 100). The first packet 30 includes a communication layer portion 32 and an application layer portion 34. Stored in the communication layer portion 32 is communication layer data 36 which may comprise, in the context of a TCP/IP network, layers 1-3 of the OSI model, or layers 1-4 of the OSI model. The communication layer data 36 may include information used by the switch 14 to properly route the packet 30, such as a destination IP address.

Stored in the application layer portion 34 is application layer data 38, which includes waypoint data 40. The waypoint data 40 includes a waypoint list 42 that identifies a plurality of nodes 12 in a path of nodes 12 that the packet 30 is to transit from the source node 12_{S} to the destination node 12_{D}. In some embodiments, the waypoint list 42 may also identify the source node 12_{S} that originated the packet 30. The application layer data 38 also includes a payload 44, which is the data generated or otherwise originated by the source node 12_{S} for communication to the destination node 12_{D}.

The waypoint list 42, as discussed above, is a list of nodes 12 on a path that the packet 30 is to transit from the source node 12_{S} to the destination node 12_{D}. The waypoint list 42 may be generated by the source node 12_{S} or may be provided to the source node 12_{S} upon request by a node 12 that has a role of generating waypoint lists 42 for the nodes 12 upon request.

Each packet 30 generated by the source node 12_{S} may contain a different waypoint list 42 so that each packet 30 transits a different path of nodes 12 on the way to the destination node 12_{D}. The example waypoint list 42 identifies a path that comprises the source node 12_{S} (Node-A), the intermediate node 12_{I1} (Node-B), the intermediate node 12_{I2} (Node-C), and the destination node 12_{D} (Node-D). In some embodiments the source node 12_{S} may not be identified in the waypoint list 42.

The source node 12_{S} addresses the packet 30 to the first intermediate node 12_{I1} on the path identified in the waypoint list 42 (FIG. 2, block 102). The source node 12_{S} encrypts the application layer data 38 to form encrypted application layer data 38. The application layer data 38 may be encrypted using any known encryption protection mechanism or technologies, but generally, such encryption should make it difficult, impracticable, or impossible for the interloper 28 to interpret any data contained in the application layer data 38. Note that the waypoint data 40 is part of the encrypted application layer data 38, and thus is not capable of being interpreted by the interloper 28. The source node 12_{S} may leave the communication layer data 36 unencrypted so that the switch 14 may properly process the packet 30.

The source node 12_{S} then sends the packet 30 to the intermediate node 12_{I1} (FIG. 2, block 104). The packet 30 may first be received by the switch 14, which may be incapable of decrypting the application layer data 38, but extracts the address of the intermediate node 12_{I1} from the communication layer data 36 of the packet 30. The switch 14 than communicates the packet 30 to the intermediate node 12_{I1}. Note that the packet 30 may also be received by the interloper 28. The interloper 28 cannot decrypt the waypoint list 42, so the interloper 28 does not know the true destination of the packet 30. From the perspective of the interloper 28, the final destination of the packet 30 is the intermediate node 12_{I1}.

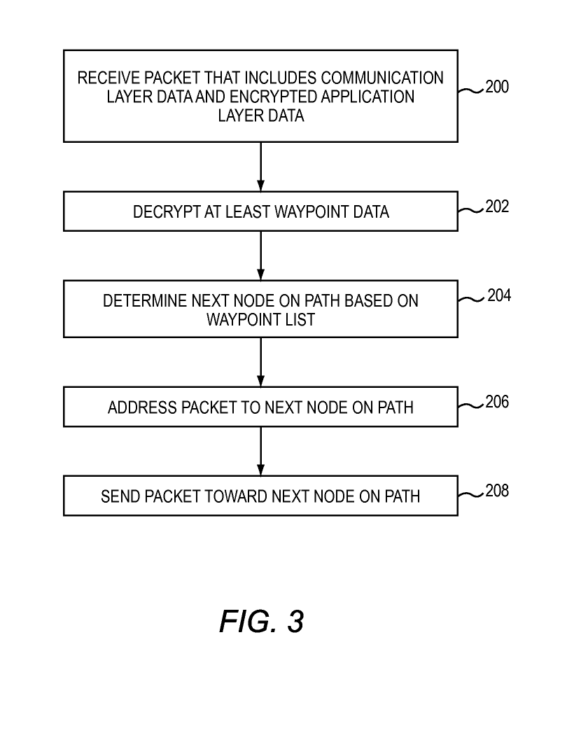

FIG. 3 is a flowchart of a method for relaying a packet received from an upstream node 12 toward a downstream node 12 by an intermediate node 12_{I} according to one embodiment. FIG. 3 will be discussed in conjunction with FIG. 1. The intermediate node 12_{I1} receives the packet 30 sent by the source node 12_{S} (FIG. 3, block 200). The intermediate node 12_{I1} has the encryption key necessary for decryption of the packet 30, and the relay module 26 of the intermediate node 12_{I1} decrypts the application layer data 38 contained in the application layer portion 34, or decrypts at least the waypoint data 40 (FIG. 3, block 202). The relay module 26 of the intermediate node 12_{I1} uses the waypoint list 42 to determine the next node 12 on the path identified in the waypoint list 42 (FIG. 3, block 204). In this example, the intermediate node 12_{I1} determines that the intermediate node 12_{I2} (Node-C) is the next node 12 on the path. The relay module 26 of the intermediate node 12_{I1} addresses the packet 30 to the intermediate node 12_{I2} (FIG. 3, block 206). In the context of an IP network, to address the packet 30 to the intermediate node 12_{I2}, the relay module 26 of the intermediate node 12_{I1} inserts the IP address of the intermediate node 12_{I2} into the destination address field of the packet 30 maintained in the communication layer data 36.

The waypoint list 42 may identify each node 12 on the path by an identifier, or by an address such as an IP address, or both. If the waypoint list 42 identifies each node 12 by address, the intermediate node 12_{I1} may obtain the address of the intermediate node 12_{I2} from the waypoint list 42. If the waypoint list 42 identifies each node 12 by an identifier other than address, the intermediate node 12_{I1} may store information in the memory 20, such as a table, that correlates the identifier information of the intermediate node 12_{I2} with the IP address of the intermediate node 12_{I2}, or, the intermediate node 12_{I1} may communicate with another device to obtain the IP address of the intermediate node 12_{I2} using the identifier of the intermediate node 12_{I2}. At a time T2, the intermediate node 12_{I1} sends the packet 30 toward the intermediate node 12_{I2} (FIG. 3, block 208). Because the packet 30 may have been processed entirely by the relay module 26 of the intermediate node 12_{I1}, the application module 24 of the intermediate node 12_{I1} may never have been interrupted to process the packet 30. Thus, in some embodiments, the relay module 26 may run independently of the application module 24, only passing packets 30 to the application module 24 that are ultimately destined for that particular node 12.

The packet 30 sent by intermediate node 12_{I1} toward the intermediate node 12_{I2} may first be received by the switch 14, which extracts the address of the intermediate node 12_{I2} from the communication layer data 36 of the packet 30. The switch 14 then communicates the packet 30 to the intermediate node 12_{I2}.

The intermediate node 12_{I2} receives the packet 30 sent by the intermediate node 12_{I1} through the switch 14. Note that the interloper 28 may also receive the packet 30 sent by the intermediate node 12_{I1} to the intermediate node 12_{I2}. The interloper 28 is unable to decrypt the application layer data 38 contained in the application layer portion 34, and thus is unable to identify the packet 30 sent by the intermediate node 12_{I1} to the intermediate node 12_{I2} as the same packet 30 sent by the source node 12_{S} to the intermediate node 12_{I1}. By “same packet” it is meant that the payload 44 has remained unchanged.

The intermediate node 12_{I2} also has an encryption key necessary for decryption of the packet 30, and the relay module 26 of the intermediate node 12_{I2} decrypts at least the waypoint data 40. The relay module 26 of the intermediate node 12_{I2} uses the waypoint list 42 to determine the next node 12 on the path identified in the waypoint list 42. In this example, the relay module 26 determines that the destination node 12_{D} (Node-D) is the next node 12 on the path. The relay module 26 addresses the packet 30 to the destination node 12_{D}. At a time T3, the intermediate node 12_{I2} sends the packet 30 toward the destination node 12_{D}.

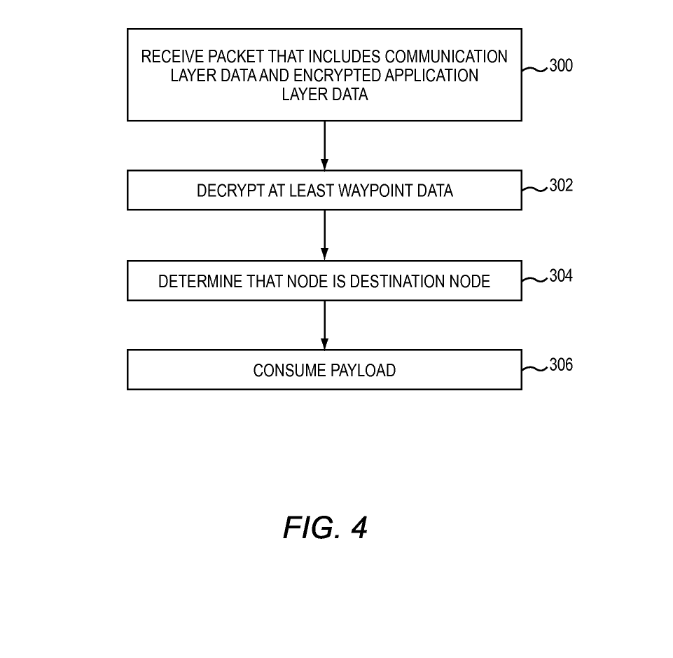

FIG. 4 is a flowchart of a method for receiving a packet 30 by a destination node 12_{D} according to one embodiment. The destination node 12_{D} receives the packet 30 sent by the intermediate node 12_{I2} (FIG. 4, block 300). Again note that the interloper 28 may also receive the packet 30 sent by the intermediate node 12_{I2} to the destination node 12_{D}. The interloper 28 is unable to decrypt the application layer data 38 contained in the application layer portion 34, and thus is unable to identify the packet 30 sent by the intermediate node 12_{I2} to the destination node 12_{D} as the same packet 30 sent by the source node 12_{S} to the intermediate node 12_{I1}, or the same packet 30 sent by the intermediate node 12_{I1} to the intermediate node 12_{I2}. To the interloper 28, the packet 30 appears to be a packet originating from the intermediate node 12_{I2}, and thus, the interloper 28 is unable to determine that ultimately the packet 30 actually originated from the source node 12_{S}.

The destination node 12_{D} also has the encryption key necessary for decryption of the packet 30, and the relay module 26 of the destination node 12_{D} decrypts at least the waypoint data 40 (FIG. 4, block 302). The relay module 26 uses the waypoint data 40 to determine that the destination node 12_{D} is, in fact, the ultimate intended destination node 12 for the packet 30 (FIG. 4, block 304). The relay module 26 may then pass the packet 30 to the application module 24 for consumption (i.e. use) (FIG. 4, block 306).

In this manner, the source node 12_{S} is able to communicate packets 30 to the destination node 12_{D} without the interloper 28 being able to determine from which node 12 a packet 30 truly originates or which node 12 ultimately consumes the packet 30.

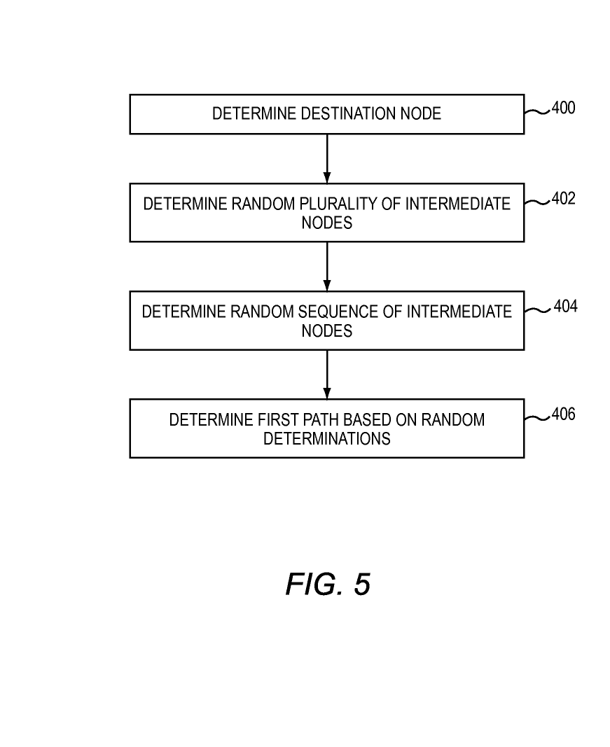

FIG. 5 is a flowchart of a method for determining a waypoint list 42 according to one embodiment. FIG. 5 will be discussed in conjunction with FIG. 1. For purposes of illustration, assume that the source node 12_{S} desires to send the packet 30 the destination node 12_{D}. The source node 12_{S} first determines that the destination node 12_{D} is the ultimate destination node for the packet 30 (FIG. 5, block 400). The source node 12_{S} may maintain a list of a plurality of nodes 12, including the intermediate nodes 12_{I1} and 12_{I2}, as well as other nodes 12 not illustrated in FIG. 1, which may be able to be identified as intermediate nodes 12_{I} on a path through which the packet 30 may transit on its way from the source node 12_{S} to the destination node 12_{D}. The source node 12_{S} may determine a random plurality of such intermediate nodes 12_{I} (FIG. 5, block 402). In other words, the source node 12_{S} may randomly determine a subset of intermediate nodes 12_{I} from a plurality of intermediate nodes 12_{I}. Once the random plurality of such intermediate nodes 12_{I} is determined, the source node 12_{S} may then determine a random sequence of the intermediate nodes 12_{I} to form a path that identifies the random plurality of intermediate nodes 12_{I} in the randomly determined sequence (FIG. 5, block 404). The source node 12_{S} then generates the waypoint list 42 identifying the randomly determined plurality of intermediate nodes 12_{I} in the randomly determined sequence (FIG. 5, block 406). The generation of a waypoint list 42 using random determinations may make it even more difficult for the interloper 28 to ascertain true source nodes 12_{S} and/or true destination nodes 12_{D}.

The embodiments are not limited to any particular mechanism for generating a waypoint list 42. In other embodiments, a source node 12_{S} may have a finite number of paths stored in the memory 20 for use in generating waypoint lists 42 depending on the particular destination node 12_{D} to which the packet 30 is ultimately destined. In yet other embodiments, the source node 12_{S} may obtain a waypoint list 42 from a waypoint list generating node 12 (not illustrated).

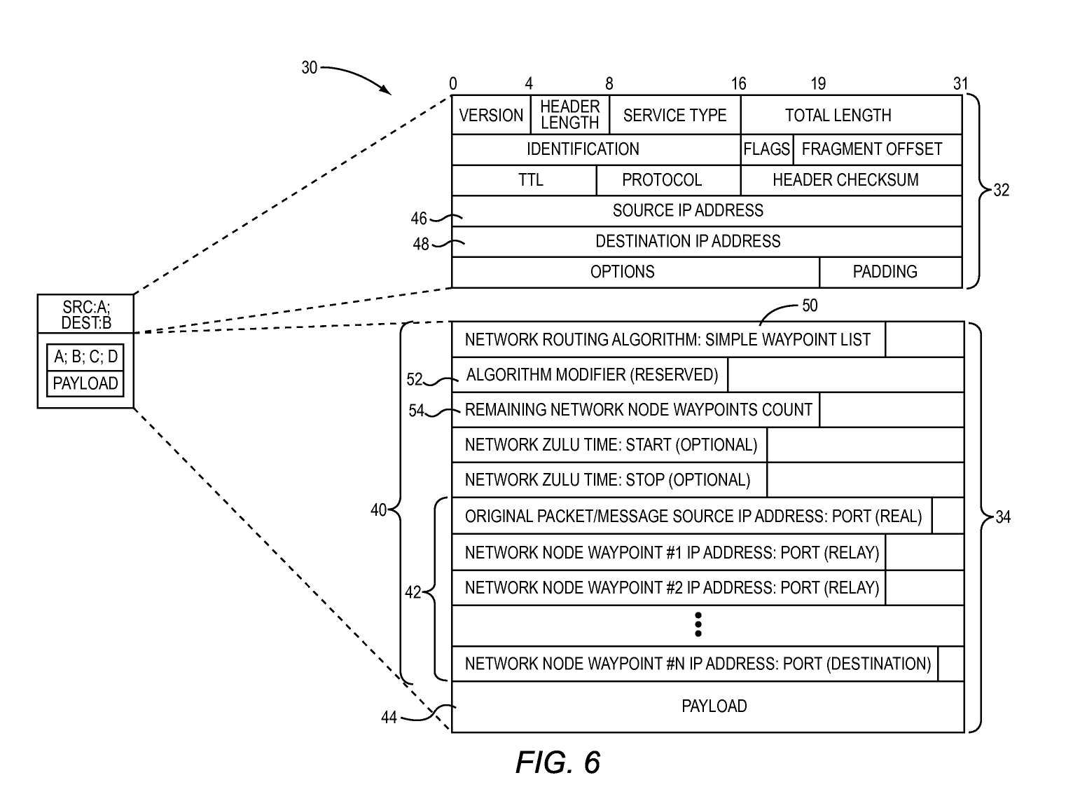

FIG. 6 is a block diagram of a format for an example packet 30 according to one embodiment. The packet 30 includes the communication layer portion 32 and the application layer portion 34. In this embodiment, the packet 30 comprises an IP packet, and the communication layer portion 32 may comprise a standard IPV4 or IPV6 communication header. Note that the communication layer portion 32 includes a source IP address field 46 into which a sending node 12 inserts the IP address of the sending node 12, and a destination address field 48, into which the sending node 12 inserts the IP address of the next node 12 on the waypoint list 42. The switch 14 may use the communication layer portion 32 for routing, switching, bridging, or otherwise processing the packet 30 to ensure the packet 30 is properly communicated toward the node 12 identified in the destination address field 48.

The waypoint data 40 includes the waypoint list 42, which identifies a plurality of nodes 12 of a path that the packet 30 will transit from the source node 12_{S} to the destination node 12_{D}. As discussed above, the waypoint list 42 may differ from one packet 30 to another packet 30, even where both packets 30 are originated from the same source node 12_{S} and destined for the same destination node 12_{D}. The waypoint list 42 may identify the source node 12_{S}, each intermediate node 12_{I}, and the destination node 12_{D}. In other embodiments, the source node 12_{S} may not be identified in the waypoint list 42.

The waypoint data 40 may also include a routing algorithm field 50 that identifies a particular routing algorithm to use when a node 12 processes the waypoint list 42. Router algorithms may include, by way of non-limiting example, a static routing algorithm, a mission specific routing algorithm, a mission-state specific routing algorithm, a per packet random routing algorithm, a multi-path routing algorithm, and a time-based routing algorithm. The routing algorithm selected may determine the manner in which the waypoint list 42 is generated by the source node 12_{S}, the way the waypoint list 42 is processed by an intermediate node 12_{I}, or both. For example, the time-based routing algorithm may identify a time, such as 3 seconds, that each intermediate node 12_{I} should wait prior to forwarding the packet 30 to the next node 12 on the waypoint list 42. The use of different routing algorithms may further frustrate the ability of the interloper 28 from discerning information about the network. The routing algorithm used may differ from packet to packet.

An algorithm modifier field 52 may include a parameter that modifies the behavior of the routing algorithm, such as time, event, redundant route(s), packet delivery confirmation, or the like. The algorithm modifier field 52 may be algorithm specific. It may comprise any suitable format, including, for example, a 32-bit word bit field of optional on/off switches, or a number of 48-bit data words (e.g., IPv6 addresses), that designate certain behavior or behaviors, such as: Packet Delivery Confirmation acknowledgement required; what ZULU time or times the routing algorithm will change its behavior; if the packet 30 is undeliverable then send a message back to the source node 12_{S} indicating what intermediate node 12_{I} was unable to complete packet delivery; a redundant static path for packet transmission along with the current waypoint list 42; directions to deliver only in ten minute bursts, otherwise store received packets 30 and forward on next ten minute burst; or periodic EMCON (Emission (or packet transmissions) Control).

The waypoint data 40 may also include a waypoint list counter field 54 that contains a waypoint list counter value. In one embodiment, the waypoint list counter value may be used by a node 12 to facilitate determining the next node 12 in the waypoint list 42 to which the packet 30 should be addressed. In one embodiment, the waypoint list counter value may be decremented by a value of one by each node 12 that processes the packet 30. When the packet 30 arrives at the destination node 12_{D}, the waypoint list counter value may have a value of zero, or one, and be used by the destination node 12_{D} to determine that the destination node 12_{D} is the final destination node 12_{D}. In other embodiments, a waypoint list counter value may not be used, and the waypoint list 42 may be processed directly by the node 12 to determine the next node 12 on the path, or whether the node 12 is the ultimate destination node 12_{D}.

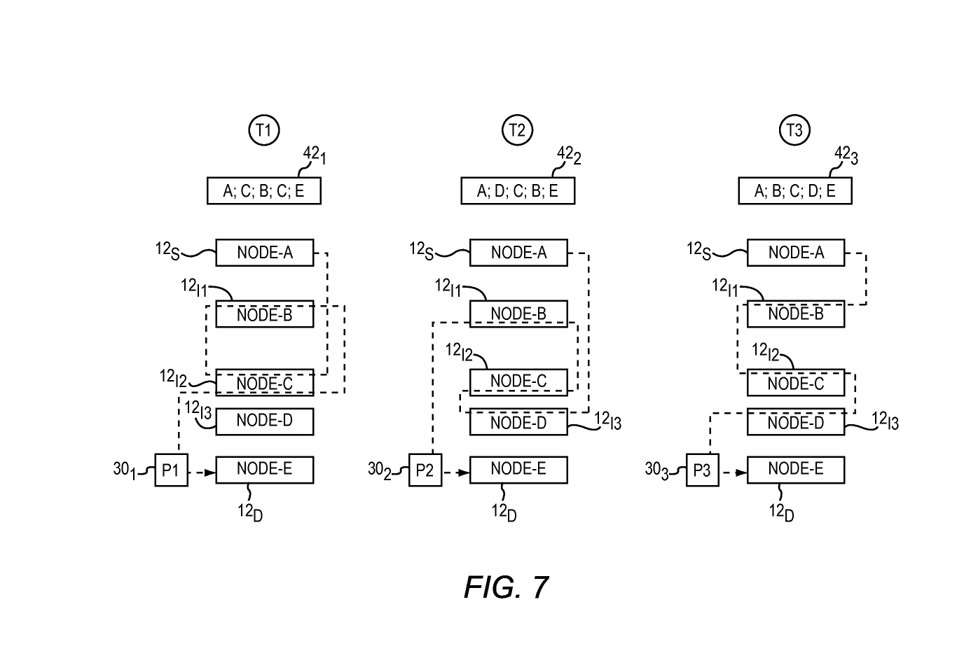

FIG. 7 is a block diagram illustrating consecutive packets being sent by a source node 12_{S} to a destination node 12_{D} using different waypoint lists 42 according to one embodiment. Assume for purposes of illustration that the source node 12_{S} comprises a video camera generating a stream of images for communication to the destination node 12_{D}. Each packet 30 generated by the source node 12_{S} comprises a frame of image data. At a time T1, the source node 12_{S} generates a first packet 30₁. The source node 12_{S} generates a first waypoint list 42₁ which identifies a path of nodes 12, in particular the intermediate node 12_{I2} (Node-C), the intermediate node 12_{I1} (Node-B), the intermediate node 12_{I2} (Node-C); and the destination node 12_{D} (Node-E). The source node 12_{S} addresses the first packet 30₁ to the first intermediate node 12_{I2} on the path, and sends the first packet 30₁ toward the first intermediate node 12_{I2}. The first packet 30₁ ultimately transits the path identified in the first waypoint list 42₁, in a manner similar to that discussed above, and ultimately arrives at the destination node 12_{D}, where the first packet 30₁ is consumed.

At a time T2, the source node 12_{S} generates a second packet 30₂ that contains a successive frame of image data generated by the source node 12_{S}. Time T2 may be microseconds after time T1. The source node 12_{S} generates a second waypoint list 42₂ which identifies a path of nodes 12, in particular the intermediate node 12_{I3} (Node-D), the intermediate node 12_{I2} (Node-C), the intermediate node 12_{I1} (Node-B); and the destination node 12_{D} (Node-E). The source node 12_{S} addresses the second packet 30₂ to the first intermediate node 12_{I3} on the path, and sends the second packet 30₂ toward the first intermediate node 12_{I3}. The second packet 30₂ ultimately transits the path identified in the second waypoint list 42₂, in a manner similar to that discussed above, and ultimately arrives at the destination node 12_{D}, where the second packet 30₂ is consumed.

At a time T3, the source node 12_{S} generates a third packet 30₃ that contains a successive frame of image data generated by the source node 12_{S}. Time T3 may be microseconds after time T2. The source node 12_{S} generates a third waypoint list 42₃ which identifies a path of nodes 12, in particular the intermediate node 12_{I1} (Node-B), the intermediate node 12_{I2} (Node-C), the intermediate node 12_{I3} (Node-D); and the destination node 12_{D} (Node-E). The source node 12_{S} addresses the third packet 30₃ to the first intermediate node 12_{I1} on the path, and sends the third packet 30₃ toward the first intermediate node 12_{I1}. The third packet 30₃ ultimately transits the path identified in the third waypoint list 42₃, in a manner similar to that discussed above, and ultimately arrives at the destination node 12_{D}, where the third packet 30₃ is consumed. Note that each packet 30₁-30₃ was sent to the destination node 12_{D} by a different intermediate node 12_{I}, making it difficult or impossible for the interloper 28 to determine that the three packets 30₁-30₃ are related to one another in terms of sequence, or originated from the source node 12_{S}.

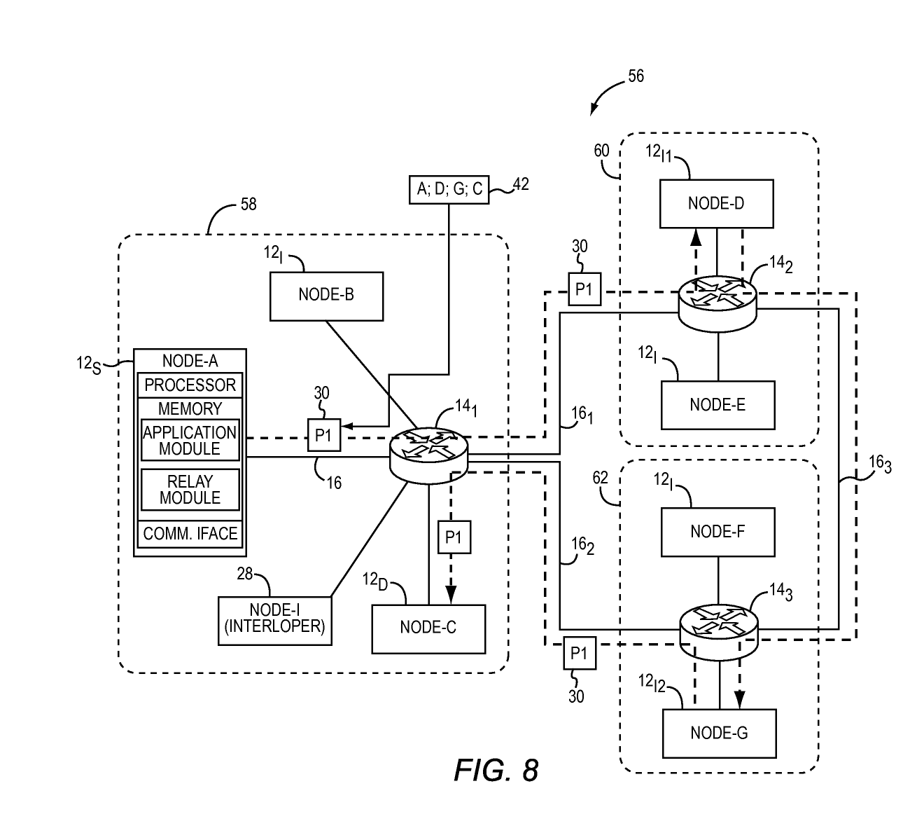

FIG. 8 is a block diagram of a system 56 in which additional embodiments may be practiced. In this embodiment, a plurality of networks 58, 60 and 62 are interconnected by wide area communication links 16₁, 16₂ and 16₃. The wide area communication link 16₁ may comprise, for example a satellite communications link, the wide area communication link 16₂ may comprise, for example an optical communications link, and the wide area communication link 16₃ may comprise, a cellular communication link. In this embodiment the source node 12_{S} generates a waypoint list 42 that identifies a path of nodes 12 to comprise a first intermediate node 12_{I1} (Node-D) that is on the network 60, a second intermediate node 12_{I2} (Node-G) that is on the network 62, and a destination node 12_{D} (Node-C) that is on the same network 58 as the source node 12_{S}. The source node 12_{S} communicates the packet 30 toward the first intermediate node 12_{I1} The switch 14₁ receives the packet 30 and examines a routing table stored in the switch 14₁, and determines that the first intermediate node 12_{I1} is not on the network 58, but is on the network 60. The switch 14₁ then communicates the packet over the satellite communications link 16₁ to the switch 14₂ for further switching.

The switch 14₂ receives the packet 30, determines that the packet 30 is destined for the first intermediate node 12_{I1}, and sends the packet 30 to the first intermediate node 12_{I1}. The first intermediate node 12_{I1} decrypts at least the waypoint list 42, determines that the second intermediate node 12_{I2} is the next node in the path identified in the waypoint list 42, and inserts the address of the second intermediate node 12_{I2} into the destination address field 48 of the packet 30. The first intermediate node 12_{I1} then sends the packet 30 toward the second intermediate node 12_{I2}.

The switch 14₂ receives the packet 30 and examines a routing table stored in the switch 14₂, and determines that the second intermediate node 12_{I2} is not on the network 60, but is on the network 62. The switch 14₂ then communicates the packet 30 over the cellular communication link 16₃ to the switch 14₃.

The switch 14₃ receives the packet 30, determines that the packet 30 is destined for the second intermediate node 12_{I2}, and sends the packet 30 to the second intermediate node 12_{I2}. The second intermediate node 12_{I2} decrypts at least the waypoint list 42, determines that the destination node 12_{D} on the network 58 is the next node in the path identified in the waypoint list 42, and inserts the address of the destination node 12_{D} into the destination address field 48 of the packet 30. The second intermediate node 12_{I2} then sends the packet 30 toward the destination node 12_{D}.

The switch 14₃ receives the packet 30 and examines a routing table stored in the switch 14₃, and determines that the destination node 12_{D} is not on the network 62, but is on the network 58. The switch 14₃ then communicates the packet 30 over the optical communication link 16₂ to the switch 14₁.

The switch 14₁ receives the packet 30, determines that the packet 30 is destined for the destination node 12_{D}, and sends the packet 30 to the destination node 12_{D}. The destination node 12_{D} consumes the packet 30. Note that to the interloper 28, the packet 30 transmitted by the source node 12_{S} left the network 58, and the interloper 28 has no means of determining that the packet 30 received by the destination node 12_{D} is the same packet 30 as the packet 30 sent by the source node 12_{S}. To the interloper 28 the two packets 30 are unrelated to one another.

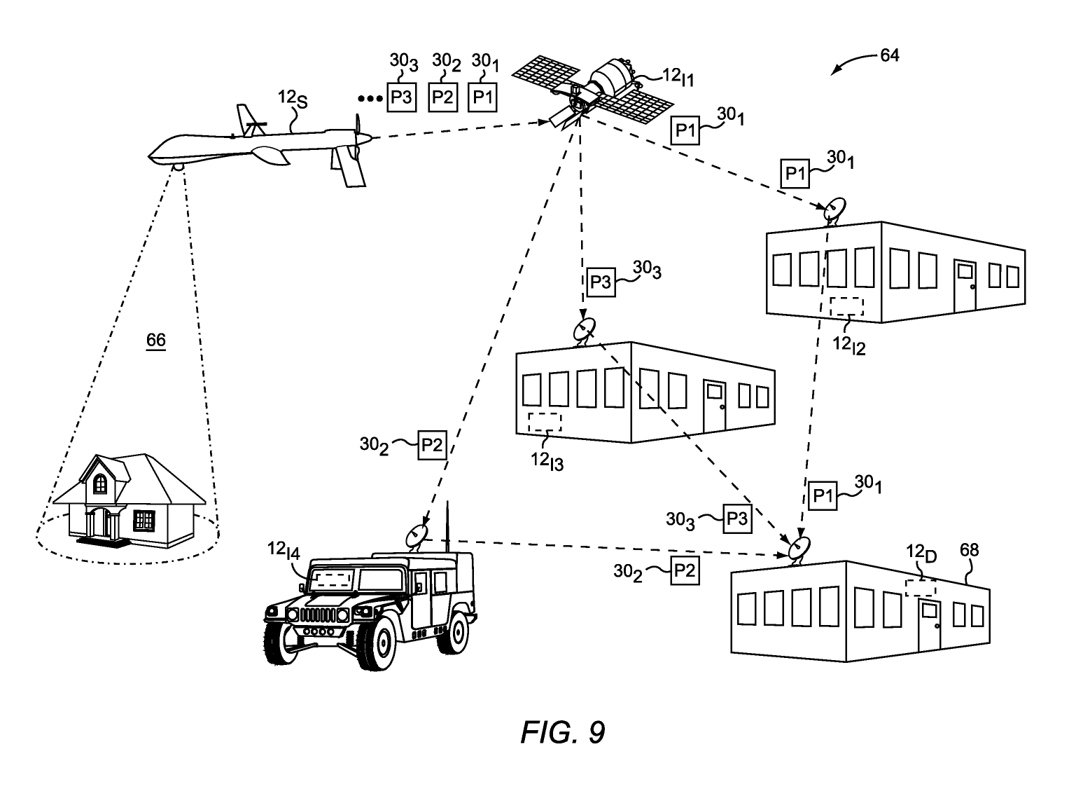

FIG. 9 is a block diagram of a system 64 in which additional embodiments may be practiced. The source node 12_{S} in this embodiment comprises a drone aircraft. The source node 12_{S} flies over an area 66 of interest and takes continuous video over a period of time. The source node 12_{S} generates a plurality of packets 30, including packets 30₁-30₃, which contain imagery of the area 66 for processing by the destination node 12_{D}, which, in this embodiment, is housed in a building 68. The source node 12_{S} generates different waypoint lists 42 for each of the packets 30₁-30₃. The source node 12_{S} may only be able to communicate with a satellite or other aircraft, given the particular airborne location of the source node 12_{S}, so the first intermediate node 12_{I1} for each packet 30₁-30₃ may, in some embodiments, be the same. Subsequent intermediate nodes 12_{I} may differ. Thus, the packet 30₁ may transit a path from the source node 12_{S} to a first intermediate node 12_{I1}, a second intermediate node 12_{I2}, and the destination node 12_{D}. The packet 30₂ may transit a path from the source node 12_{S} to a first intermediate node 12_{I1}, a second intermediate node 12_{I4}, which in this example comprises a ground vehicle, such as a Humvee®, and the destination node 12_{D}. The packet 30₃ may transit a path from the source node 12_{S} to a first intermediate node 12_{I1}, a second intermediate node 12_{I3}, and the destination node 12_{D}.

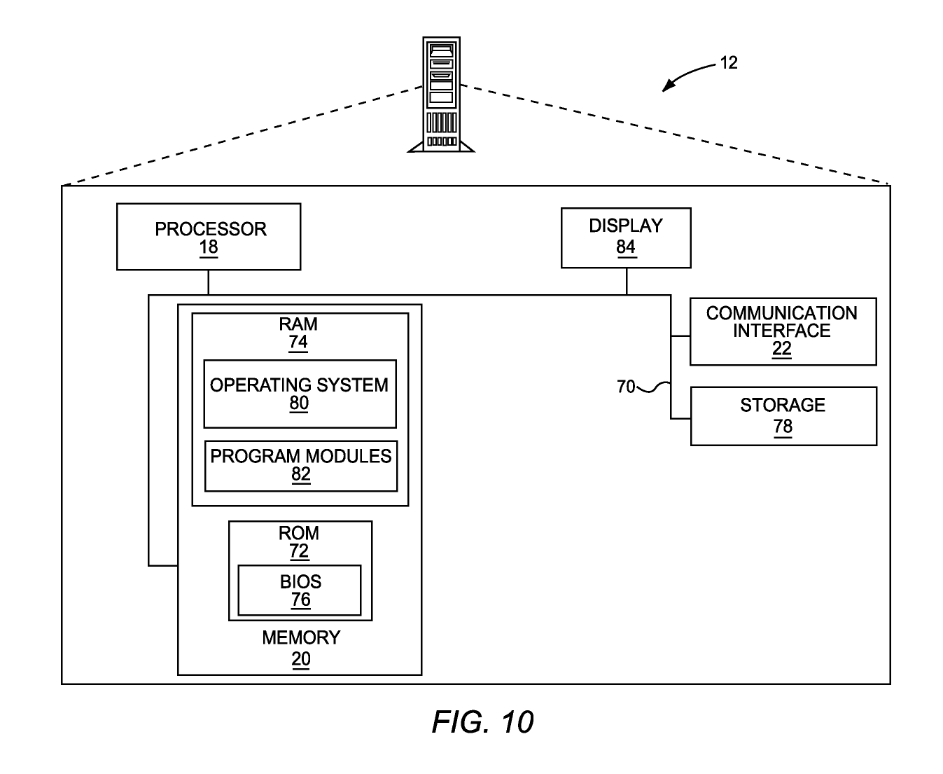

FIG. 10 is a block diagram illustrating an example node 12 suitable for implementing functionality of the source node 12_{S}, intermediate node 12_{I} or destination node 12_{D} described herein. The node 12 may comprise any computing or processing device capable of executing software instructions and/or containing circuitry for implementing the functionality described herein. The node 12 includes the processor 18, the memory 20, and a system bus 70. The system bus 70 provides an interface for system components including, but not limited to, the memory 20 and the processor 18. The processor 18 can be any commercially available or proprietary processor. Dual micro-processors and other multi-processor architectures may also be employed as the processor 18.

The system bus 70 may be any of several types of bus structures that may further interconnect to a memory bus (with or without a memory controller), a peripheral bus, and/or a local bus using any of a variety of commercially available bus architectures. The memory 20 may include non-volatile memory 72 (e.g., read only memory (ROM), erasable programmable read only memory (EPROM), electrically erasable programmable read only memory (EEPROM), etc.) and/or volatile memory 74 (e.g., random access memory (RAM)). A basic input/output system (BIOS) 76 may be stored in the non-volatile memory 72, and can include the basic routines that help to transfer information between elements within the node 12. The volatile memory 74 may also include a high-speed RAM, such as static RAM for caching data.

The node 12 may further include a computer-readable storage 78, which may comprise, for example, an internal hard disk drive (HDD) (e.g., enhanced integrated drive electronics (EIDE) or serial advanced technology attachment (SATA)), HDD (e.g., EIDE or SATA) for storage, flash memory, or the like. The computer-readable storage 78 and other drives, associated with computer-readable and computer-usable media, provide non-volatile storage of data, data structures, computer-executable instructions, and the like. Although the description of computer-readable media above refers to an HDD, it should be appreciated by those skilled in the art that other types of media which are readable by a computer, such as Zip disks, magnetic cassettes, flash memory cards, cartridges, and the like, may also be used in the exemplary operating environment, and further, that any such media may contain computer-executable instructions for performing novel methods of the disclosed architecture.

A number of modules can be stored in the computer-readable storage 78 and in the volatile memory 74, including an operating system 80 and one or more program modules 82, which may implement the functionality described herein in whole or in part, including, for example, the relay module 26 and the application module 24, and other processing and functionality described herein. It is to be appreciated that the embodiments can be implemented with various commercially available operating systems 80 or combinations of operating systems 80.

All or a portion of the embodiments may be implemented as a computer program product stored on a transitory or non-transitory computer-usable or computer-readable storage medium, such as the computer-readable storage 78, which includes complex programming instructions, such as complex computer-readable program code, configured to cause the processor 18 to carry out the steps described herein. Thus, the computer-readable program code can comprise software instructions for implementing the functionality of the embodiments described herein when executed on the processor 18. The processor 18, in conjunction with the program modules 82 in the volatile memory 74, may serve as a control system for the node 12 that is configured to, or adapted to, implement the functionality described herein. The node 12 may also include the communication interface 22 for communicating with a network. The node 12 may also include a display 84 that provides information to an operator or user.

Those skilled in the art will recognize improvements and modifications to the preferred embodiments of the present disclosure. All such improvements and modifications are considered within the scope of the concepts disclosed herein and the claims that follow.

What is claimed is:

1. A method for communicating data from a source node to a destination node, comprising:
generating, by the source node, a first packet comprising:
first communication layer data; and
first encrypted application layer data, the first encrypted application layer data including:
a first payload; and
first waypoint data that comprises a first waypoint list that identifies one or more nodes of a first path of nodes that the first packet is to transit from the source node to the destination node;
addressing the first packet to an intermediate node on the first path; and
sending the first packet toward the intermediate node.

2. The method of claim 1, further comprising determining the first path of nodes.

3. The method of claim 2, wherein determining the first path of nodes comprises:
determining the destination node;
determining a random subset of intermediate nodes from a plurality of intermediate nodes;
determining a random sequence of the subset of intermediate nodes; and
determining the first path to comprise the source node, the subset of intermediate nodes in the random sequence, and the destination node.

4. The method of claim 1, wherein the first communication layer data is unencrypted.

5. The method of claim 1, wherein addressing the first packet to the intermediate node comprises inserting an address of the intermediate node in a destination address field in the first communication layer data.

6. The method of claim 5, wherein the address of the intermediate node is used by one or more switching nodes to route the first packet through the network to the intermediate node.

7. The method of claim 5, wherein the address comprises an Internet Protocol address that identifies the intermediate node.

8. The method of claim 1, further comprising generating, by the source node, a second packet comprising second communication layer data and second encrypted application layer data, the second encrypted application layer data comprising a second payload and second waypoint data that comprises a second waypoint list that identifies one or more nodes of a second path of nodes that the second packet is to transit from the source node to the destination node, the second path of nodes being different from the first path of nodes.

9. The method of claim 8, wherein the first payload comprises a first video segment in a succession of a plurality of video segments, and the second payload comprises a subsequent video segment in the succession of the plurality of video segments.

10. The method of claim 1, wherein the second waypoint data comprises a waypoint list counter value that is based on a number of the nodes on the first path of nodes.

11. The method of claim 1, wherein the first waypoint data identifies the source node, a plurality of intermediate nodes, and the destination node.

12. A method, comprising:
receiving, by an intermediate node from an upstream node, a packet comprising:
communication layer data; and
encrypted application layer data, the encrypted application layer data comprising a payload and waypoint data that includes a waypoint list that identifies one or more nodes of a path of nodes that the packet is to transit from a source node to a destination node;
decrypting at least the waypoint data;
determining a next node on the path of nodes based on the waypoint list;
addressing the packet to the next node; and
sending the packet toward the next node.

13. The method of claim 12, wherein determining the next node on the path of nodes based on the waypoint list comprises obtaining an address of the next node on the path of nodes from the waypoint list; and
wherein addressing the packet to the next node on the path of nodes comprises inserting an address of the next node in a destination address field in the communication layer data.

14. The method of claim 12, wherein the waypoint data further comprises a waypoint list counter value, and further comprising:
decrementing the waypoint list counter value; and
re-encrypting at least the waypoint data.

15. A method for receiving a packet on a network, comprising:
receiving, by a destination node from a first upstream node, a first packet comprising:
first communication layer data; and
first encrypted application layer data, the first encrypted application layer data including:
a first payload; and
first waypoint data that comprises a first waypoint list that identifies one or more nodes of a first path of nodes that the first packet is to transit from a source node to the destination node;
decrypting at least the first waypoint data;
based on the waypoint data, determining that the first packet is destined for the destination node; and
consuming the first payload.

16. The method of claim 15, further comprising:
receiving, by the destination node from a second upstream node, a second packet comprising:
second communication layer data; and
second encrypted application layer data, the second encrypted application layer data including:
a second payload; and
second waypoint data that comprises a second waypoint list that identifies one or more nodes of a second path of nodes that the second packet is to transit from the source node to the destination node;
decrypting at least the second waypoint data;
accessing the second waypoint data;
based on the second waypoint data, determining that the second packet is destined for the destination node; and
consuming the second payload.

17. The method of claim 16, wherein the first payload comprises a first video segment in a succession of a plurality of video segments originating from the source node, and the second payload comprises a subsequent video segment in the succession of the plurality of video segments originating from the source node.

18. A source node, comprising:
a communication interface configured to communicate with a network; and
a processor coupled to the communication interface and configured to:
generate a first packet comprising:
first communication layer data; and
first encrypted application layer data, the first encrypted application layer data including:
a first payload; and
first waypoint data that comprises a first waypoint list that identifies one or more nodes of a first path of nodes that the first packet is to transit from the source node to a destination node;
address the first packet to an intermediate node on the first path of nodes; and
send the first packet toward the intermediate node.

19. An intermediate node, comprising:
a communication interface configured to communicate with a network; and
a processor coupled to the communication interface and configured to:
receive, from an upstream node, a packet comprising:
communication layer data; and
encrypted application layer data, the encrypted application layer data comprising a payload and waypoint data that includes a waypoint list that identifies one or more nodes of a path of nodes that the packet is to transit from a source node to a destination node;
decrypt at least the waypoint data;
determine a next node on the path of nodes based on the waypoint list;
address the packet to the next node; and
send the packet toward the next node.
